(19) United States
(12) Patent Application Publication
(10) Pub. No.: US 2026/0147714 A1
(43) Pub. Date: May 28, 2026

(54) METHOD AND APPARATUS WITH DATA PRELOADING

(71) Applicant: Samsung Electronics Co., Ltd., Suwon-si (KR)

(72) Inventors: Junyeon LEE, Suwon-si (KR); Jin-Hong KIM, Suwon-si (KR); Seok-Young YOON, Suwon-si (KR); Seungho LEE, Suwon-si (KR); Jungsik CHOI, Suwon-si (KR)

(73) Assignee: Samsung Electronics Co., Ltd., Suwon-si (KR)

(21) Appl. No.: 19/202,768

(22) Filed: May 8, 2025

(30) Foreign Application Priority Data
Nov. 26, 2024 (KR) 10-2024-0171040

(51) Int. Cl. G06F 12/1009

(52) U.S. Cl. CPC G06F 12/1009; G06F 2212/656; G06F 2212/657

(57) ABSTRACT

A method and apparatus with data preloading are provided. The method includes obtaining a preloading command for a global memory, writing a global memory address to a routing table, allocating a local memory address corresponding to the global memory address, requesting a movement of shared data stored at the global memory address to the local memory address, and writing the local memory address to a location in the routing table corresponding to the global memory address in response to completion of the movement.

### CROSS-REFERENCE TO RELATED APPLICATIONS

This application claims the benefit under 35 USC § 119(a) of Korean Patent Application No. 10-2024-0171040, filed on Nov. 26, 2024, in the Korean Intellectual Property Office, the entire disclosure of which is incorporated herein by reference for all purposes.

### BACKGROUND

### 1. Field

The following description relates to a method and apparatus with data preloading.

### 2. Description of Related Art

With the rapid development of artificial intelligence (AI) and high-performance computing (HPC), the demand for systems capable of processing large-scale data sets and complex operations continues to grow. In particular, deep learning model training and inference require continuous loading of substantial amounts of data into memory, making memory bandwidth and access latency critical concerns. The typical memory access method loads data from remote memory only when requested by a central processing unit (CPU), which can lead to significant performance degradation due to high latency.

To address memory access performance and capacity limitations, distributed shared memory (DSM) or global memory architectures have been introduced, allowing a plurality of nodes to share one virtual memory space. In a DSM system, physically distributed memory may be used as a single virtual memory space, enabling each node to access memories of other nodes. However, this global memory access method increases network bandwidth usage and imposes additional overhead from global address conversion and consistency maintenance. In AI model training, where large volumes of data are processed consecutively, latency in loading necessary data from remote memory may significantly impact model training speed.

The above information may be presented as the related art to help with the understanding of the disclosure. No arguments or decisions are made as to whether any of the above is applicable as a prior art related to the disclosure.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one general aspect, a processor-implemented method includes receiving a preloading request for a global memory; writing a global memory address to a routing table; allocating a local memory address corresponding to the global memory address; requesting a movement of shared data stored at the global memory address to the local memory address; and writing the local memory address to a location in the routing table corresponding to the global memory address in response to completion of the movement.

The method may further include modifying mapping information in a page table for the global memory address based on the local memory address.

The method may further include reading the shared data from the local memory address in response to receiving a read command for the shared data after the mapping information is modified.

The method may further include reading the shared data from the global memory address in response to receiving a read command for the shared data before the mapping information is modified.

The receiving of the preloading request may further include obtaining the global memory address and length information of the shared data.

The allocating of the local memory address may be performed based on the length information of the shared data.

The receiving of the preloading request may include receiving a predefined pragma that indicates the preloading request.

The receiving of the preloading request may include receiving an application programming interface (API) call corresponding to the preloading request.

The receiving of the preloading request may include predicting, based on a previously preloaded memory address, a time point at which preloading is required; and receiving the preloading request based on the predicted time point.

In one general aspect, an operation method includes dividing input data into a plurality of mini-batches and allocating each of the plurality of mini-batches to a plurality of nodes; preloading, by each of the plurality of nodes, a parameter corresponding to a next stage via shared memory; releasing, by each of the plurality of nodes, a parameter corresponding to a preloaded previous stage; and performing, by each of the plurality of nodes, an operation for a current stage based on the allocated mini-batches and a parameter corresponding to a preloaded current stage.

The operation of the current stage may include one or more of a forward operation, a backward operation, and a weight-update operation of an artificial neural network model.

The preloading of the parameter may include, by each of the plurality of nodes, obtaining a preloading command for a global memory; writing a global memory address to a routing table; allocating a local memory address corresponding to the global memory address; requesting a movement of a parameter corresponding to the next stage stored at the global memory address to the local memory address; and writing the local memory address to a location in the routing table corresponding to the global memory address in response to completion of the movement.

In one general aspect, provided is a non-transitory computer-readable storage medium storing code that, when executed by one or more processors, may configure the one or more processors to perform the method described herein.

In one general aspect, an electronic device include one or more processors respectively comprising processing circuitry; and a memory storing instructions, wherein the instructions, when individually or collectively executed by the one or more processors, configure the one or more processors to: obtain a preloading command for a global memory; write a global memory address to a routing table; allocate a local memory address corresponding to the global memory address; request a movement of shared data stored at the global memory address to the local memory address; and write the local memory address to a location in the routing table corresponding to the global memory address in response to completion of the movement.

The one or more processors may be further configured to modify mapping information in a page table for the global memory address based on the local memory address.

The one or more processors may be further configured to read the shared data from the local memory address in response to receiving a read command for the shared data after the mapping information of the page table is modified.

The one or more processors may be further configured to read the shared data from the global memory address in response to receiving a read command for the shared data before the mapping information of the page table is modified.

The one or more processors may be further configured to obtain the global memory address and length information of the shared data.

The one or more processors may be further configured to allocate the local memory address based on the length information of the shared data.

Other features and aspects will be apparent from the following detailed description, the drawings, and the claims.

### BRIEF DESCRIPTION OF THE DRAWINGS

FIG. 1 illustrates an example distributed memory system according to one or more embodiments.

FIG. 2 illustrates an example configuration of software to implement a preloading function according to one or more embodiments.

FIG. 3 illustrates an example mechanism of preloading data from a global memory to a local memory according to one or more embodiments.

FIGS. 4A and 4B illustrate respective example model training by applying pipeline parallelism without data preloading according to the related art.

FIGS. 5A and 5B illustrate respective example model training by applying pipeline parallelism using data preloading according to one or more embodiments.

FIG. 6 illustrates an example preloading method according to one or more embodiments.

FIG. 7 illustrates an example training method of an artificial neural network model according to one or more embodiments.

FIG. 8 illustrates an example electronic device according to one or more embodiments.

Throughout the drawings and the detailed description, unless otherwise described or provided, the same drawing reference numerals may be understood to refer to the same or like elements, features, and structures. The drawings may not be to scale, and the relative size, proportions, and depiction of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of the disclosure of this application. For example, the sequences within and/or of operations described herein are merely examples, and are not limited to those set forth herein, but may be changed as will be apparent after an understanding of the disclosure of this application, except for sequences within and/or of operations necessarily occurring in a certain order. As another example, the sequences of and/or within operations may be performed in parallel, except for at least a portion of sequences of and/or within operations necessarily occurring in an order, e.g., a certain order. Also, descriptions of features that are known after an understanding of the disclosure of this application may be omitted for increased clarity and conciseness.

The features described herein may be embodied in different forms, and are not to be construed as being limited to the examples described herein. Rather, the examples described herein have been provided merely to illustrate some of the many possible ways of implementing the methods, apparatuses, and/or systems described herein that will be apparent after an understanding of the disclosure of this application. The use of the term “may” herein with respect to an example or embodiment (e.g., as to what an example or embodiment may include or implement) means that at least one example or embodiment exists where such a feature is included or implemented, while all examples are not limited thereto. The use of the terms “example” or “embodiment” herein have a same meaning (e.g., the phrasing “in one example” has a same meaning as “in one embodiment”, and “one or more examples” has a same meaning as “in one or more embodiments”).

Throughout the specification, when a component, element, or layer is described as being “on”, “connected to,” “coupled to,” or “joined to” another component, element, or layer it may be directly (e.g., in contact with the other component, element, or layer) “on”, “connected to,” “coupled to,” or “joined to” the other component, element, or layer or there may reasonably be one or more other components, elements, layers intervening therebetween. When a component, element, or layer is described as being “directly on”, “directly connected to,” “directly coupled to,” or “directly joined” to another component, element, or layer there can be no other components, elements, or layers intervening therebetween. Likewise, expressions, for example, “between” and “immediately between” and “adjacent to” and “immediately adjacent to” may also be construed as described in the foregoing.

Although terms such as “first,” “second,” and “third”, or A, B, (a), (b), and the like may be used herein to describe various members, components, regions, layers, or sections, these members, components, regions, layers, or sections are not to be limited by these terms. Each of these terminologies is not used to define an essence, order, or sequence of corresponding members, components, regions, layers, or sections, for example, but used merely to distinguish the corresponding members, components, regions, layers, or sections from other members, components, regions, layers, or sections. Thus, a first member, component, region, layer, or section referred to in the examples described herein may also be referred to as a second member, component, region, layer, or section without departing from the teachings of the examples.

The terminology used herein is for describing various examples only and is not to be used to limit the disclosure. The articles “a,” “an,” and “the” are intended to include the plural forms as well, unless the context clearly indicates otherwise. As non-limiting examples, terms “comprise” or “comprises,” “include” or “includes,” and “have” or “has” specify the presence of stated features, numbers, operations, members, elements, and/or combinations thereof, but do not preclude the presence or addition of one or more other features, numbers, operations, members, elements, and/or combinations thereof, or the alternate presence of an alternative stated features, numbers, operations, members, elements, and/or combinations thereof. Additionally, while one embodiment may set forth such terms “comprise” or “comprises,” “include” or “includes,” and “have” or “has” specify the presence of stated features, numbers, operations, members, elements, and/or combinations thereof, other embodiments may exist where one or more of the stated features, numbers, operations, members, elements, and/or combinations thereof are not present.

As used herein, the term “and/or” includes any one and any combination of any two or more of the associated listed items. The phrases “at least one of A, B, and C”, “at least one of A, B, or C”, and the like are intended to have disjunctive meanings, and these phrases “at least one of A, B, and C”, “at least one of A, B, or C” (e.g., each phrase may include any one of the respective items alone, all of the items listed together, and all possible combinations thereof), and the like also include examples where there may be one or more of each of A, B, and/or C (e.g., any combination of one or more of each of A, B, and C), unless the corresponding description and embodiment necessitates such listings (e.g., “at least one of A, B, and C”) to be interpreted to have a conjunctive meaning.

Unless otherwise defined, all terms, including technical and scientific terms, used herein have the same meaning as commonly understood by one of ordinary skill in the art to which this disclosure pertains and specifically in the context on an understanding of the disclosure of the present application. Terms, such as those defined in commonly used dictionaries, are to be interpreted as having a meaning that is consistent with their meaning in the context of the relevant art and specifically in the context of the disclosure of the present application, and are not to be interpreted in an idealized or overly formal sense unless expressly so defined herein.

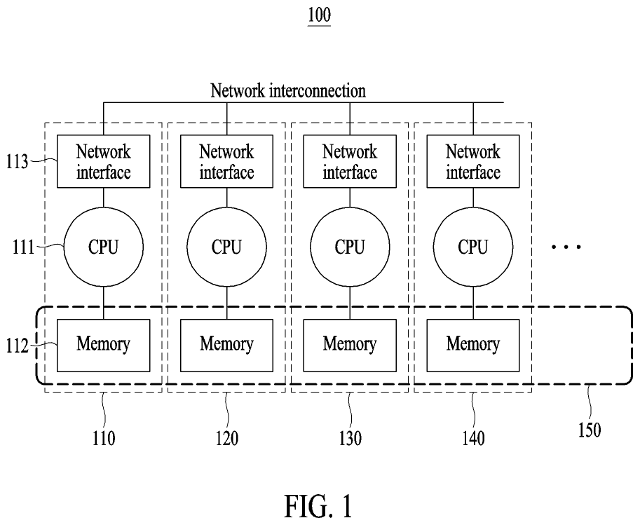

FIG. 1 illustrates an example distributed memory system according to one or more embodiments.

Referring to FIG. 1, a distributed memory system 100 may include a plurality of nodes (e.g., nodes 110, 120, 130, and 140) and a global memory 150. In the example of FIG. 1, the four nodes 110, 120, 130, and 140 are depicted; however, in practice the number of nodes may be greater, or in a small-scale system, the number of nodes may be reduced to two or three. Thus, the system configuration may be adapted based on the application requirements or network resource constraints.

A node is an independent computation device that may comprise a central processing unit (CPU) and a memory. Each node (such as nodes 110, 120, 130, and 140) may include an independently configured processor (e.g., a CPU, or a graphics processing unit (GPU)), a local memory, and a network interface. As a non-limiting example, the node 110 may include a CPU 111, a memory 112, and a network interface 113.

The local memory (e.g., the memory 112) is an independent memory space that is accessible only by a corresponding one of the nodes 110, 120, 130, and 140 and may be a dedicated memory where a processor of the corresponding node may read or write data. Since the local memory is an independent area that may not be accessed by other nodes, data sharing between the nodes 110, 120, 130, and 140 may be achieved via the global memory 150. In one or more embodiments, a portion of the local memory may be allocated as part of the global memory 150, while the remaining portion continues to function as dedicated local memory.

The nodes 110, 120, 130, and 140 may be interconnected through their network interfaces (e.g., the network interface 113), which facilitate data transmission and exchange of operation results. These network interfaces may also support data communication between the CPU of each of the nodes 110, 120, 130, and 140 and external node(s), enabling cooperative operations in a distributed environment.

The global memory 150 may server as a shared memory space accessible by all nodes 110, 120, 130, and 140, functioning as a central memory for the nodes 110, 120, 130, and 140 to access common data. The global memory 150 may be implemented using a centralized memory server, a distributed shared memory (DSM) system, and/or a high-performance storage, thereby allowing all nodes 110, 120, 130, and 140 to share data via a unified/same global memory address space.

For example, when data generated by the node 110 needs to be used by the other nodes 120, 130, and 140, the node 110 may store the data in the global memory 150. The other nodes 120, 130, and 140 may then access the global memory 150 through the respective network interfaces 113 to read or use the data. By this configuration, each of the nodes 110, 120, 130, and 140 may share the data indirectly via the global memory 150 without directly accessing another node's local memory.

The distributed memory system 100, comprising the nodes 110, 120, 130, and 140, may operate as a collaborative structure of computing devices configured to process large-scale data. Such a configured system may be used in various fields such as artificial intelligence (AI) model training, scientific simulation, and big data analysis.

For example, training a large-scale language model (LLM) may involve processing vast amounts of data and managing billions of parameters. Because a single computer may lack sufficient memory and computational power to handle such a workload, multiple computers may need to cooperate and share computations to perform the training efficiently. In this case, the nodes 110, 120, 130, and 140 may cooperative via the distributed memory system 100.

In the distributed memory system 100, each of the nodes 110, 120, 130, and 140 may include an independent operation device (such as a GPU and the like) and the local memory and may be responsible for executing a portion of the overall model computation to contribute to distributed training. The global memory 150 may interconnect the nodes 110, 120, 130, and 140, enable them to share data. For example, when one node preprocesses predetermined text data and stores the predetermined text data in the global memory 150, other nodes may read and use the corresponding data directly from the global memory 150. This approach may eliminate the need for data copying between the nodes 110, 120, 130, and 140, allowing each node to independently access necessary data for computation.

However, because the distributed memory system 100 does not inherently consider the physical location of memory during programming, performance degradation may occur. For example, when data that is frequently used by the node 110 is allocated to a memory space of the node 120, network latency may arise when the node 110 accesses the data, thereby degrading overall performance.

To mitigate such latency, the distributed memory system 100 may employ a preloading technique, where data from the global memory 150 is copied to the local memory in advance. For example, when the node 110 requires frequent access to predetermined data stored in the global memory 150, preloading that data into its local memory allows for rapid access when needed. This approach may minimize the access latency to the global memory 150 and optimize the overall system performance.

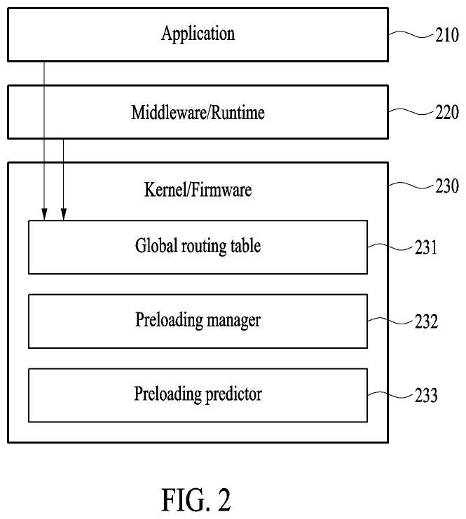

FIG. 2 illustrates an example configuration of software to implement a preloading function according to one or more embodiments. The description provided with reference to FIG. 1 may also apply to FIG. 2.

Referring to FIG. 2, nodes (e.g., the nodes 110, 120, 130, and 140 of FIG. 1) may include a structure comprising an application layer 210, a middleware/runtime layer 220, and a kernel/firmware layer 230 to perform preloading functions. Each layer may play a different role, enabling effectively management of the preloading process and minimizing data access latency.

The term “layer” used herein may refer to a unit including one or a combination of two or more of hardware, software, and/or firmware. The “layer” may be used interchangeably with terms “module,” “unit,” “logic,” “logical block,” “component,” or “circuit.” A “layer” may represent a minimum unit of an integrally formed component or a functional part thereof, and may be implemented either mechanically or electronically. For example, a “layer” may include at least one of an application-specific integrated circuit (ASIC) chip, a field-programmable gate array (FPGA), or a programmable-logic device to perform certain operations, whether presently known or developed in the future.

The application layer 210 and the middleware/runtime layer 220 may represent entities that may generate preloading requests. Such a request may originate directly from the application layer 210 or from the middleware/runtime layer 220. For example, an AI model training application may initiate a preloading request for data and/or model parameters needed for training. A database application may request preloading of index and/or cache data that a runtime environment frequently accesses.

The kernel/firmware layer 230 may process the preloading request and perform data management and optimization between a global memory and a local memory. The kernel/firmware layer 230 may include a global routing table 231, a preloading manager 232, and a preloading predictor 233. Based on the preloading request, the kernel/firmware layer 230 may preload necessary data into the local memory and perform various functions to maximize data access efficiency.

The global routing table 231 may function as a database that stores mapping information between a global memory address g_addr and a local memory address l_paddr. The mapping information may be managed in a page unit and may include attributes such as an Accessed bit, a Dirty bit, and a Present bit if needed. These bits may represent the data access and modification state, whether these bits currently exist in a memory, etc., and may be used for efficient memory management and performance optimization. For example, when a certain global virtual address is frequently accessed, a corresponding Accessed bit may signal the preloading predictor 233 to determine whether to preload the corresponding data. When a preloading request is issued, the system may determine whether data of a corresponding global memory address should be copied to the local memory via the global routing table 231, and the data may be mapped to a certain address of the local memory so that an application may quickly access the data. For example, when a global address of weight data that is frequently used by an AI training model is registered in the global routing table 231, the corresponding data may be copied (preloaded) to the local memory, allowing quick access to the corresponding data.

The preloading manager 232 may manage access authority/permissions, life cycles, timestamps (e.g., last access time), etc., of a preloaded memory. The preloading manager 232 may configure how long preloaded data remains in a memory, allowing a system operator to enhance the efficiency of memory usage. For example, For example, data not accessed within a predetermined period may be automatically eliminated, while data that is frequently used may be retained for longer periods, thereby optimizing memory resource utilization.

The preloading predictor 233 may further enhance system performance by analyzing recent data access patterns. The preloading predictor 233 may train a past data access pattern and preload data that is expected to be needed in the future, thereby increasing the access speed. For example, when a pattern of consecutive access to certain data is detected, the preloading predictor 233 may train the pattern and then preload the pattern to the local memory when the same type of data is needed, thereby reducing latency due to unexpected data access and improving overall system performance.

For example, when an AI training application repeatedly accesses a particular parameter stored in the global memory, a preloading request may be generated in the application layer 210 or the middleware/runtime layer 220. The system may establish a mapping between a global address and a local address of the corresponding parameter in the global routing table 231 of the kernel/firmware layer 230, and the preloading manager 232 may copy the designated data from the global memory to the local memory and manage the designated data. Additionally, the preloading predictor 233 may learn from this pattern and may preemptively preload similar data in the future, thereby preventing performance degradation.

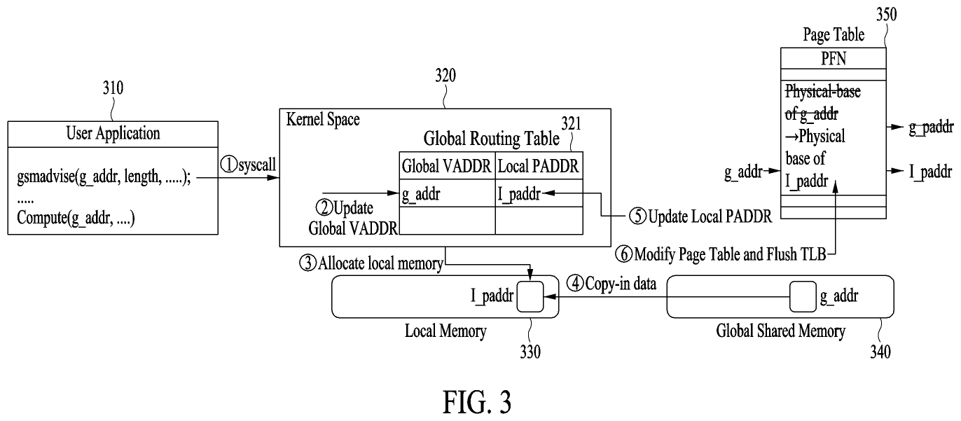

FIG. 3 illustrates an example mechanism of preloading data from a global memory to a local memory according to one or more embodiments. The description provided with reference to FIGS. 1 and 2 may also apply to FIG. 3.

When certain data needs to be preloaded from a global memory 340 to a local memory 330, a user application 310 may transmit a preloading request to a kernel 320 via an application programming interface (API) (e.g., a gsmadvice API) or a predefined indicator (e.g., pragma). The preloading request may include the global virtual address g_addr and length information of corresponding data. For example, when an AI training application requires repeated used of a large-scale parameter, the global virtual address g_addr of the corresponding parameter and the length information of the data may be transmitted to the kernel 320 to prepare the data for rapid access from the local memory 330.

The global virtual address g_addr may identify certain data within the global memory 340 of a distributed memory system. The global virtual address g_addr may be referenced identically by all nodes, allowing consistent access to the data stored in the global memory 340. That is, the data stored in the global memory 340 may be accessed via the global virtual address g_addr, enabling multiple nodes to read from or write to the same data in the distributed system regardless of its physical location.

For example, when a training parameter of an AI model is stored in the global memory 340, each node may access the parameter using the global virtual address g_addr. This uniform addressing scheme may allow all nodes in the distributed memory system to share data stored in the global memory 340. The global virtual address g_addr may also be referred to as a global memory address.

The kernel 320 may receive the preloading request, record the global virtual address g_addr in a global virtual address field Global VADDR of a global routing table 321 by referring to the global routing table 321, and be allocated a space in the local memory 330 based on the length of the corresponding data. Here, a physical address of the allocated space may be designated as the local memory address l_paddr. In this configuration, the kernel 320 may generate mapping information indicating that the data is to be stored at the local memory address l_paddr for the global virtual address g_addr (i.e., linking g_addr to l_paddr).

The local memory address l_paddr may be an actual physical address used for storing and accessing data in the local memory 330 of an individual/particular node. The local memory address l_paddr may be valid only in a memory space of a certain node and may be directly accessible by its processor. This mechanism enables each node to preload data into local memory 330 and access it rapidly.

The kernel 320 may subsequently request a direct memory access (DMA) engine to transfer data from the global virtual address g_addr in the global memory 340 to the local memory address l_paddr in the local memory 330. The DMA engine may perform the task of copying data from the global virtual address g_addr to the local memory address l_paddr and may be designed to allow the user application 310 to access the data directly from the global memory 340 even while the data is being copied to the local memory 330. That is, the data of the global virtual address g_addr may be accessed even before the preloading task is completed, thereby preventing access latency.

The DMA engine may copy the data from the global virtual address g_addr to the local memory address l_paddr quickly and efficiently because the transferring operation between memories occurs without processor intervention. For example, when a large-scale parameter is copied during AI model training, the DMA engine may quickly move the data to the local memory 330, facilitating subsequent quick access.

When the data is copied, the kernel 320 may update the mapping information by recording the local memory address l_paddr in a local memory address field Local PADDR of the global routing table 321. Through this configuration, future requests to access the global virtual address g_addr are directed by the kernel 320 to retrieve data from the local memory address l_paddr in the local memory 330 rather than from the global memory 340, thereby reducing access latency.

The kernel 320 may find/retrieve mapping information for the global virtual address g_addr from a page table 350, modify the mapping information to point to the local memory address l_paddr, and simultaneously flush a cached translation look-aside buffer (TLB), so the updated mapping information is reflected and effective. From this point forward, the user application 310 may access the data from the local memory 330. Accordingly, when the user application 310 subsequently accesses the global virtual address g_addr, the data may be quickly accessed from the local memory address l_paddr through the modified page table 350.

For example, when an AI model training application repeatedly requires a large-scale parameter stored in the global memory 340, the user application 310 may transmit, to the kernel 320, the global virtual address g_addr of a corresponding parameter and the length information of the data via a preloading request. The kernel 320 may establish the mapping information in the global routing table 321 and use the DMA engine to copy the data from the global virtual address g_addr to the local memory address l_paddr. Afterward, the page table 350 may be modified to map the global virtual address g_addr to the local memory address l_paddr, and the TLB is flushed to optimize data access speed. This approach ensures that the training data is quickly accessible from the local memory 330, thereby significantly enhancing system performance.

Through this mechanism, the one or more embodiments described may reduce the data access latency by preloading data from the global memory 340 to the local memory 330, thereby optimizing the overall system performance.

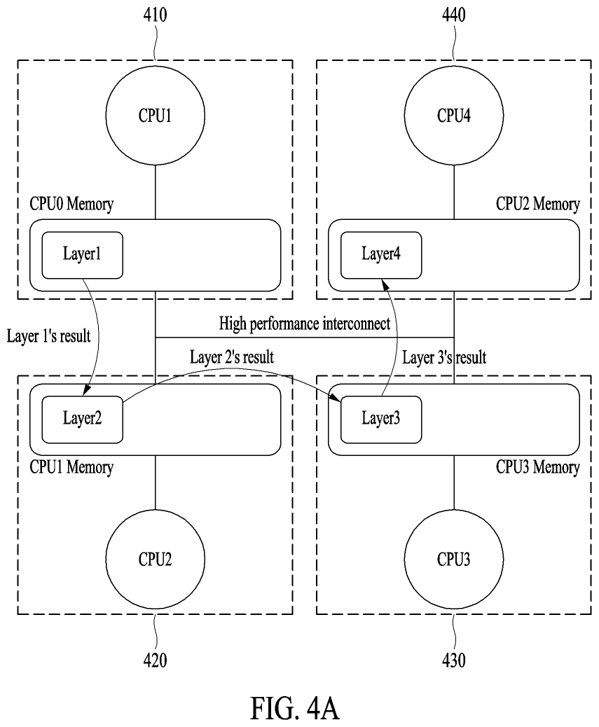

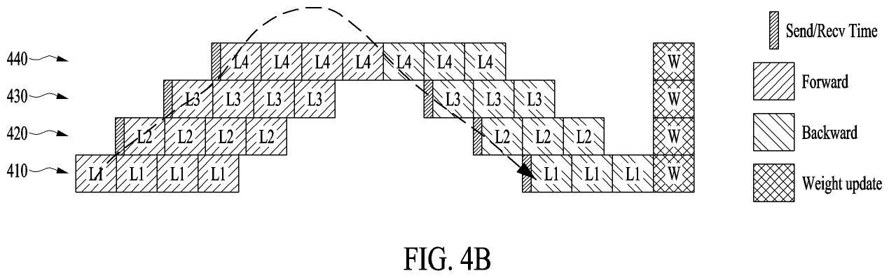

FIGS. 4A and 4B illustrate examples of performing model training applying pipeline parallelism without data preloading according to the related art.

A pipeline parallelism method is introduced to enable training in a distributed environment regardless of model size while increasing resource efficiency by dividing and allocating each model layer to a plurality of CPUs. However, the pipeline parallelism method of the related art exhibits certain limitations.

Referring to FIG. 4A, CPU 1 410 may be responsible for processing layer 1 of a model and, upon completion of a mini-batch, may transmit the result of processing the layer 1 to CPU 2 420. The CPU 2 420 may then process layer 2 and transmit the result of processing the layer 2 to CPU 3 430, with the final result sequentially transmitted to CPU 4 440. This sequential operation enables efficient training of large-scale models by dividing the model into N parts that are processed in parallel by distributed CPUs. Furthermore, this method can address the inefficiencies associated with conventional data parallelism (DP) or model parallelism (MP).

However, this pipeline parallelism method according to the related art has the following problems. First, each CPU requires the output from the preceding layer before commencing its operation. For example, the CPU 2 420 must wait for the CPU 1 410 to complete an operation on the layer 1 and then to perform an operation on the layer 2, leading to an idle state during the startup stage of a pipeline. Although the waiting problem may be alleviated when the pipeline progresses to a certain extent and reaches a steady stage, resource inefficiency remains unavoidable during initialization.

Second, the idle time in the pipeline may increase when the amount of operation of each stage is imbalanced. In particular, since a backward operation generally requires more computation time than that of a forward operation, additional overhead may be incurred to maintain the ratio (appropriate balance) between these operations.

FIG. 4B illustrates an example process in which the forward, backward, and weight update stages are sequentially performed in the pipeline parallelism method of the related art, along with the associated data transmission latency between the stages.

In FIG. 4B, a model may divide and allocate each layer (e.g., layers 1, 2, 3, and 4) to a respective CPU (e.g., CPU 1 410, CPU 2 420, CPU 3 430, and CPU 4 440). Each layer may perform a forward operation, a backward operation, and a weight-update operation. The solid arrows indicate the transmission and/or reception time when data transmission occurs between the layers.

As described above, since each layer may start an operation only when receiving the operation result of a previous layer while the forward operation is performed, the forward operation may be performed sequentially in which each layer performs operations sequentially and transmits the result to the next layer. For example, when the forward operation of the layer 1 is completed in the CPU 1 410, the result may be transmitted to the CPU 2 420 so that the forward operation may be performed on the layer 2. In this manner, the forward pass may be completed only when the sequential forward operations across all layers have been performed.

The backward operation may require a higher amount of computation than that of the forward operation, resulting in longer processing times. This time imbalance between the forward and backward operations can adversely affect the overall training speed. In particular, when operations are executed sequentially in a pipeline parallelism framework, discrepancies in processing times may cause unnecessary idle periods. As shown in FIG. 4B, the cumulative transmission delays between the layers during the backward operation contribute to an inefficient waiting state between the data access and the operation.

Moreover, because the weight-update operation must be performed after the forward and backward operations, waiting periods between the operation stages may further increase overhead to the overall training process. The weight-update operation is the task of updating the parameters of each layer, and as the weight-update operation is also performed sequentially in the pipeline, the associated data transmission delays and inter-stage latencies accumulate, exacerbating inefficiencies in the training process.

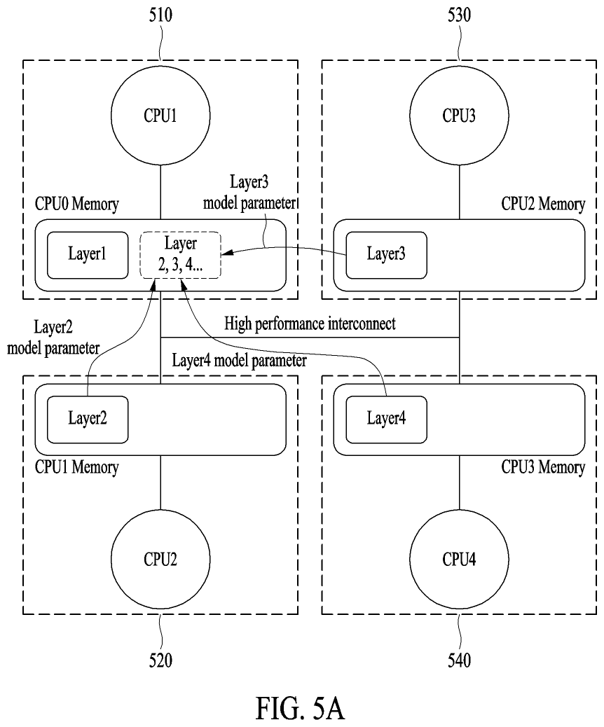

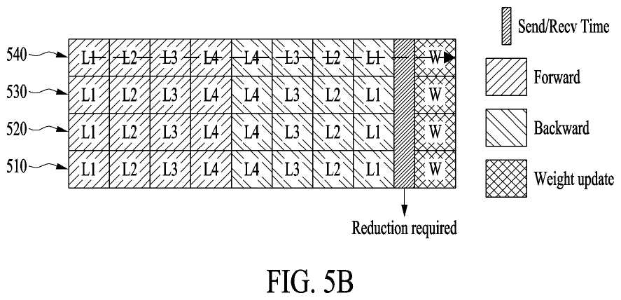

These problems may be mitigated by employing data preloading via a global shared memory. Hereinafter, a method of performing model training using applying pipeline parallelism with preloading is described in detail with reference to FIGS. 5A and 5B.

FIGS. 5A and 5B illustrate respective example model training by applying pipeline parallelism with data preloading according to one or more embodiments. The descriptions provided with reference to FIGS. 1 to 3 may also apply to FIGS. 5A and 5B.

In the typical pipeline method according to the related art, training and inference may be performed by transmitting the computation result of one layer to the subsequent CPU. In contrast, in one or more embodiments of the data preloading technique, each CPU may independently perform its computation by preloading a model parameter of a layer required for the next stage without transmitting the result.

In one or more embodiments, as shown in FIG. 5A, CPU 1 510 may preload a model parameter for layer 2 before processing layer 1. Upon completing the operation for layer 1, CPU 1 510 may concurrently process the layer 2 while preloading a model parameter for layer 3. In this way, when the operation for the layer 2 is completed, the CPU 1 510 may release a memory allocated for the layer 2 and preload a model parameter for layer 4, thereby enabling sequential processing of the layers 3 and 4. Similarly, CPU 2 520, CPU 3 530, and CPU 4 540 may use the preloading technique to prepare necessary data in advance, thereby enhancing the efficiency of pipeline parallelism.

FIG. 5B provides a visual representation of the preloading-based pipeline parallelism method. In the existing pipeline method, each operation is performed sequentially and data transmission latency occurs between layers. However, with the preloading technique according to one or more embodiments, each CPU may perform its operation independently, reducing data transmission latency and improving overall operational efficiency.

The preloading-based pipeline parallelism method offers several advantages. First, computation imbalance between the layers is mitigated because each node performs its computation independently, thereby eliminating the overhead associated with balancing in conventional model or pipeline parallelism. Second, even when preloading is incompleted, a remote memory may be directly accessed without blocking to perform an operation, with a local memory being accessed to continue computation once preloading is completed. Although remote memory access may incur cache inefficiency, it reduces overall data access latency. Third, scheduling overhead of each layer may be minimized and an additional memory space for weight stashing may be unnecessary. Fourth, compared to conventional pipeline parallelism method, this method increases throughput and reduces the latency. The data preloading technique according to one or more embodiments may solve the idle bubble problem typically observed during the startup stage of a pipeline, which is a significant improvement that could not be achieved in the pipeline parallelism method according to the related art.

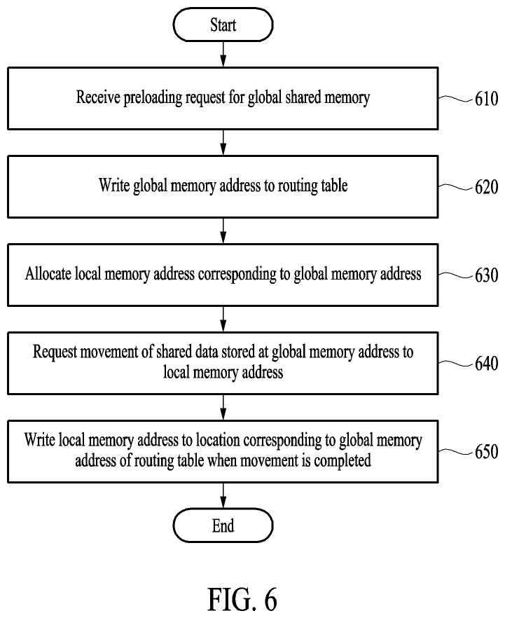

FIG. 6 illustrates an example preloading method according to one or more embodiments. The descriptions provided with reference to FIGS. 1 to 5B may substantially apply to FIG. 6.

For ease of description, operations 610 to 650 may be described as being performed by the nodes 110, 120, 130, and 140 of the distributed memory system 100 illustrated in FIG. 1. However, these operations 610 to 650 may also be performed by any suitable electronic device in any appropriate system.

Moreover, the operations of FIG. 6 may be performed in the shown order and manner. However, the order of some operations may change, or some operations may be omitted, without departing from the spirit and scope of the shown example. The operations illustrated in FIG. 6 may be performed in parallel or simultaneously.

In operation 610, a node may receive a preloading request for a global shared memory and obtain a corresponding global memory address and length information of shared data. The node may receive a predefined indicator (e.g., pragma) indicating the preloading request, or an API call corresponding to the preloading request. Additionally, the node may predict a time point at which preloading is required, based on a previously preloaded memory address, and may receive the preloading request based on the predicted time point.

In operation 620, the node may write the global memory address to a routing table.

In operation 630, the node may allocate a local memory address corresponding to the global memory address, based on the length information of the shared data.

In operation 640, the node may request a transfer/movement of the shared data stored at the global memory address to the local memory address.

In operation 650, upon completion of the data movement, the node may write the local memory address to a location corresponding to the global memory address of the routing table.

The node may modify mapping information of the global memory address of a page table based on the local memory address. When a read command for the shared data is received after this modification, the node may access the shared data from the local memory address. When the read command for the shared data is received prior to this modification, the node may access the shared data from the global memory address.

The descriptions provided with reference to FIGS. 1 to 5B may apply to the operations shown in FIG. 6, and thus, a further detailed description thereof is omitted.

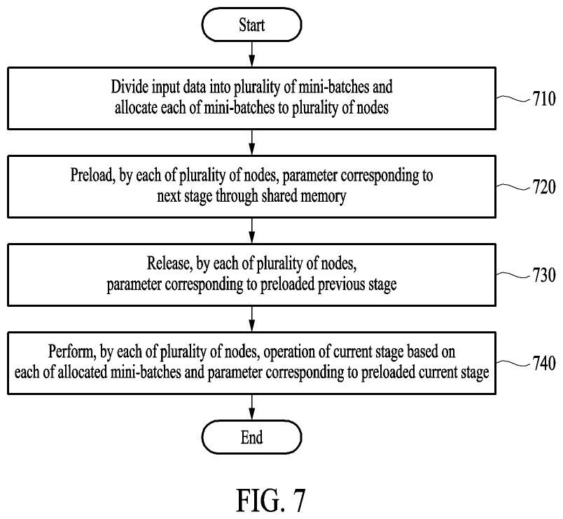

FIG. 7 illustrates an example training method of an artificial neural network model according to one or more embodiments. The description provided with reference to FIGS. 1 to 6 may substantially apply to FIG. 7.

For ease of description, operations 710 to 740 are described as being performed by the nodes 110, 120, 130, and 140 of the distributed memory system 100 illustrated in FIG. 1. However, operations 710 to 740 may also be performed by any suitable electronic device and in any appropriate system.

Similarly, the operations of FIG. 7 may be performed in the shown order and manner. However, the order of some operations may be changed, or some operations may be omitted, without departing from the spirit and scope of the shown example. The operations illustrated in FIG. 7 may be performed in parallel or simultaneously.

In operation 710, a node may divide input data into a plurality of mini-batches and allocate each mini-batch to a corresponding one of a plurality of nodes.

In operation 720, each node may preload a parameter corresponding to the next stage through a shared memory. The node may receive a preloading command for a global memory, write a global memory address to a routing table, be allocated a local memory address corresponding to the global memory address, request a movement/transfer of the parameter corresponding to the next stage stored at the global memory address to the local memory address, and write the local memory address to a corresponding entry of the routing table, which is a location corresponding to the global memory address of the routing table, when the movement is completed.

In operation 730, each node may release a parameter corresponding to a preloaded previous stage.

In operation 740, each node may perform an operation for a current stage based on a corresponding one of the allocated mini-batches and a parameter corresponding to a preloaded current stage. The operation for the current stage may include one or more of a forward operation, a backward operation, and a weight-update operation of an artificial neural network model.

Each node may perform an operation for the next/subsequent stage based on a corresponding one of the allocated mini-batches and a parameter corresponding to a preloaded next stage without transmitting the result of the operation for the next stage (e.g., intermediate feature maps or outputs) to other nodes. Such a configuration aims to avoid inter-node communication by enabling each node to independently perform its assigned portion of the operation using its allocated mini-batch and preloaded parameters, without the need to exchange results with other nodes. By eliminating the inter-node communication, which is a major bottleneck in typical model parallelism, the whole system performance is enhanced.

The descriptions provided with reference to FIGS. 1 to 6 may apply to the operations shown in FIG. 7, and thus, a further detailed description thereof is omitted.

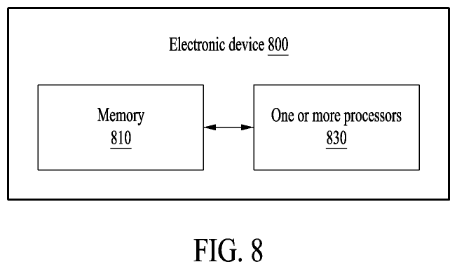

FIG. 8 illustrates an example electronic device according to one or more embodiments.

Referring to FIG. 8, an electronic device 800 may include a memory 810 and one or more processors 830. The electronic device 800 may include various computing devices, such as a mobile phone, smartphone, tablet, personal computer (PC), e-book device, laptop, desktop, workstation, or a server; various wearable devices, such as a smartwatch, smart eyeglasses, head-mounted display (HMD), or smart clothing; various home appliances, such as a smart speaker, smart television (TV), or smart refrigerator; and other devices, such as a smart vehicle, smart kiosk, Internet of Things (IoT) device, walking assist device (WAD), drone, or robot.

The memory 810 may store instructions (e.g., programs) executable by the one or more processors 830. For example, the instructions may include code for executing operations by the one or more processors 830 and/or various components of the one or more processors 830.

The memory 810 may be implemented as a volatile memory device or a non-volatile memory device.

The volatile memory device may be implemented as dynamic random-access memory (DRAM), static RAM (SRAM), thyristor RAM (T-RAM), zero capacitor RAM (Z-RAM), or twin transistor RAM (TTRAM).

The non-volatile memory device may be implemented as electrically erasable programmable read-only memory (EEPROM), flash memory, magnetic RAM (MRAM), spin-transfer torque (STT)-MRAM, conductive bridging RAM (CBRAM), ferroelectric RAM (FeRAM), phase change RAM (PRAM), resistive RAM (RRAM), nanotube RRAM, polymer RAM (PoRAM), nano floating gate memory (NFGM), holographic memory, a molecular electronic memory device, or insulator resistance change memory.

The one or more processors 830 may process data stored in the memory 810. The one or more processors 830 may execute computer-readable code (e.g., software) stored in the memory 810 and instructions triggered by the one or more processors 830.

The one or more processors 830 may each be a hardware-implemented data processing device having a circuit that is physically structured to execute desired operations. For example, the desired operations may include code or instructions included in a program.

For example, the hardware-implemented data processing device may include a microprocessor, a CPU, a processor core, a multi-core processor, a multiprocessor, an ASIC, and an FPGA.

The one or more processors 830 may obtain a preloading command for a global memory, write a global memory address to a routing table, be allocated a local memory address corresponding to the global memory address, request a transfer/movement of shared data stored at the global memory address to the local memory address, and write the local memory address to a location corresponding to the global memory address of the routing table (e.g., a corresponding entry in the routing table) when the movement is completed. The one or more processors 830 may perform operations of the distributed memory system described with reference to FIGS. 1 to 7 in substantially the same manner. Accordingly, a further description thereof is omitted herein.

The units described herein may be implemented using a hardware component, a software component and/or a combination thereof. A processing device may be implemented using one or more general-purpose or special-purpose computers, such as, for example, a processor, a controller and an arithmetic logic unit (ALU), a digital signal processor (DSP), a microcomputer, a field programmable gate array (FPGA), a programmable logic unit (PLU), a microprocessor or any other device capable of responding to and executing instructions in a defined manner. The processing device may run an operating system (OS) and one or more software applications that run on the OS. The processing device also may access, store, manipulate, process, and create data in response to execution of the software. For purpose of simplicity, the description of a processing device is used as singular; however, one skilled in the art will appreciate that a processing device may include multiple processing elements and/or multiple types of processing elements. For example, a processing device may include a plurality of processors or a processor and a controller. In addition, different processing configurations are possible, such as parallel processors.

Software may include a computer program, a piece of code, an instruction, or combinations thereof, to independently or collectively instruct or configure the processing device to operate as desired. Software and data may be embodied permanently or temporarily in any type of machine, component, physical or virtual equipment, computer storage medium or device, or in a propagated signal wave capable of providing instructions or data to or being interpreted by the processing device. The software may also be distributed over network-coupled computer systems so that the software is stored and executed in a distributed fashion. The software and data may be stored in a non-transitory computer-readable recording medium.

The electronic devices, processors, memories, storage devices, storage devices, neural network models and interfaces, network interfaces 113, CPU 111/410/420/430/440/510/520/530/540, memory 112/150/330/340/810, nodes 110, 120, 130, and 140, processors 830, and other apparatuses, devices, models, and components described herein with respect to FIGS. 1-8 are implemented by or representative of hardware components. Examples of hardware components that may be used to perform the operations described in this application where appropriate include controllers, sensors, generators, drivers, memories, comparators, arithmetic logic units, adders, subtractors, multipliers, dividers, integrators, and any other electronic components configured to perform the operations described in this application. In other examples, one or more of the hardware components that perform the operations described in this application are implemented by computing hardware, for example, by one or more processors or computers. A processor or computer may be implemented by one or more processing elements, such as an array of logic gates, a controller and an arithmetic logic unit, a digital signal processor, a microcomputer, a programmable logic controller, a field-programmable gate array, a programmable logic array, a microprocessor, or any other device or combination of devices that is configured to respond to and execute instructions in a defined manner to achieve a desired result. In one example, a processor or computer includes, or is connected to, one or more memories storing instructions or software that are executed by the processor or computer. Hardware components implemented by a processor or computer may execute instructions or software, such as an operating system (OS) and one or more software applications that run on the OS, to perform the operations described in this application. The hardware components may also access, manipulate, process, create, and store data in response to execution of the instructions or software. For simplicity, the singular term “processor” or “computer” may be used in the description of the examples described in this application, but in other examples multiple processors or computers may be used, or a processor or computer may include multiple processing elements, or multiple types of processing elements, or both. For example, a single hardware component or two or more hardware components may be implemented by a single processor, or two or more processors, or a processor and a controller. One or more hardware components may be implemented by one or more processors, or a processor and a controller, and one or more other hardware components may be implemented by one or more other processors, or another processor and another controller. One or more processors, or a processor and a controller, may implement a single hardware component, or two or more hardware components. A hardware component may have any one or more of different processing configurations, examples of which include a single processor, independent processors, parallel processors, single-instruction single-data (SISD) multiprocessing, single-instruction multiple-data (SIMD) multiprocessing, multiple-instruction single-data (MISD) multiprocessing, and multiple-instruction multiple-data (MIMD) multiprocessing.

The methods illustrated in FIGS. 1-8 that perform the operations described in this application are performed by computing hardware, for example, by one or more processors or computers, implemented as described above implementing instructions or software to perform the operations described in this application that are performed by the methods. For example, a single operation or two or more operations may be performed by a single processor, or two or more processors, or a processor and a controller. One or more operations may be performed by one or more processors, or a processor and a controller, and one or more other operations may be performed by one or more other processors, or another processor and another controller. One or more processors, or a processor and a controller, may perform a single operation, or two or more operations.

Instructions or software to control computing hardware, for example, one or more processors or computers, to implement the hardware components and perform the methods as described above may be written as computer programs, code segments, instructions or any combination thereof, for individually or collectively instructing or configuring the one or more processors or computers to operate as a machine or special-purpose computer to perform the operations that are performed by the hardware components and the methods as described above. In one example, the instructions or software include machine code that is directly executed by the one or more processors or computers, such as machine code produced by a compiler. In another example, the instructions or software includes higher-level code that is executed by the one or more processors or computer using an interpreter. The instructions or software may be written using any programming language based on the block diagrams and the flow charts illustrated in the drawings and the corresponding descriptions herein, which disclose algorithms for performing the operations that are performed by the hardware components and the methods as described above.

The instructions or software to control computing hardware, for example, one or more processors or computers, to implement the hardware components and perform the methods as described above, and any associated data, data files, and data structures, may be recorded, stored, or fixed in or on one or more non-transitory computer-readable storage media. Examples of a non-transitory computer-readable storage medium include read-only memory (ROM), random-access programmable read only memory (PROM), electrically erasable programmable read-only memory (EEPROM), random-access memory (RAM), dynamic random access memory (DRAM), static random access memory (SRAM), flash memory, non-volatile memory, CD-ROMs, CD-Rs, CD+Rs, CD-RWs, CD+RWs, DVD-ROMs, DVD-Rs, DVD+Rs, DVD-RWs, DVD+RWs, DVD-RAMs, BD-ROMs, BD-Rs, BD-R LTHs, BD-REs, blue-ray or optical disk storage, hard disk drive (HDD), solid state drive (SSD), flash memory, a card type memory such as a multimedia card or a micro card (for example, secure digital (SD) or extreme digital (XD)), magnetic tapes, floppy disks, magneto-optical data storage devices, optical data storage devices, hard disks, solid-state disks, and any other device that is configured to store the instructions or software and any associated data, data files, and data structures in a non-transitory manner and provide the instructions or software and any associated data, data files, and data structures to one or more processors or computers so that the one or more processors or computers can execute the instructions. In one example, the instructions or software and any associated data, data files, and data structures are distributed over network-coupled computer systems so that the instructions and software and any associated data, data files, and data structures are stored, accessed, and executed in a distributed fashion by the one or more processors or computers.

While this disclosure includes specific examples, it will be apparent after an understanding of the disclosure of this application that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents.

Therefore, in addition to the above disclosure, the scope of the disclosure may also be defined by the claims and their equivalents, and all variations within the scope of the claims and their equivalents are to be construed as being included in the disclosure.

What is claimed is:

1. A processor-implemented method comprising:
receiving a preloading request for a global memory;
writing a global memory address to a routing table;
allocating a local memory address corresponding to the global memory address;
requesting a movement of shared data stored at the global memory address to the local memory address; and
writing the local memory address to a location in the routing table corresponding to the global memory address in response to completion of the movement.

2. The method of claim 1, further comprising:
modifying mapping information in a page table for the global memory address based on the local memory address.

3. The method of claim 2, further comprising:
reading the shared data from the local memory address in response to receiving a read command for the shared data after the mapping information is modified.

4. The method of claim 2, further comprising:
reading the shared data from the global memory address in response to receiving a read command for the shared data before the mapping information is modified.

5. The method of claim 1, wherein the receiving of the preloading request further comprises obtaining the global memory address and length information of the shared data.

6. The method of claim 5, wherein the allocating of the local memory address is performed based on the length information of the shared data.

7. The method of claim 1, wherein the receiving of the preloading request comprises receiving a predefined pragma that indicates the preloading request.

8. The method of claim 1, wherein the receiving of the preloading request comprises receiving an application programming interface (API) call corresponding to the preloading request.

9. The method of claim 1, wherein the receiving of the preloading request comprises:
predicting, based on a previously preloaded memory address, a time point at which preloading is required; and
receiving the preloading request based on the predicted time point.

10. An operation method comprising:
dividing input data into a plurality of mini-batches and allocating each of the plurality of mini-batches to a corresponding one of a plurality of nodes;
preloading, by each of the plurality of nodes, a parameter corresponding to a next stage via shared memory;
releasing, by each of the plurality of nodes, a parameter corresponding to a preloaded previous stage; and
performing, by each of the plurality of nodes, an operation for a current stage based on each of the plurality of allocated mini-batches and a parameter corresponding to a preloaded current stage.

11. The method of claim 10, wherein the operation of the current stage comprises one or more of a forward operation, a backward operation, and a weight-update operation of an artificial neural network model.

12. The method of claim 10, further comprising:
performing, by each of the plurality of nodes, an operation for the next stage based on each of the plurality of allocated mini-batches and a parameter corresponding to a preloaded next stage without transmitting a result of operation to other nodes.

13. The method of claim 10, wherein the preloading of the parameter comprises, by each of the plurality of nodes:
obtaining a preloading command for a global memory;
writing a global memory address to a routing table;
allocating a local memory address corresponding to the global memory address;
requesting a movement of a parameter corresponding to the next stage stored at the global memory address to the local memory address; and
writing the local memory address to a location in the routing table corresponding to the global memory address in response to completion of the movement.

14. A non-transitory computer-readable storage medium storing code that, when executed by one or more processors, configures the one or more processors to perform the method of claim 1.

15. An electronic device comprising:
one or more processors respectively comprising processing circuitry; and
a memory storing instructions,
wherein the instructions, when individually or collectively executed by the one or more processors, configure the one or more processors to:
obtain a preloading command for a global memory;
write a global memory address to a routing table;
allocate a local memory address corresponding to the global memory address;
request a movement of shared data stored at the global memory address to the local memory address; and
write the local memory address to a location in the routing table corresponding to the global memory address in response to completion of the movement.

16. The electronic device of claim 15, wherein the one or more processors are further configured to modify mapping information in a page table for the global memory address based on the local memory address.

17. The electronic device of claim 16, wherein the one or more processors are further configured to read the shared data from the local memory address in response to receiving a read command for the shared data after the mapping information of the page table is modified.

18. The electronic device of claim 16, wherein the one or more processors are further configured to read the shared data from the global memory address in response to receiving a read command for the shared data before the mapping information of the page table is modified.

19. The electronic device of claim 15, wherein the one or more processors are further configured to obtain the global memory address and length information of the shared data.

20. The electronic device of claim 19, wherein the one or more processors are further configured to allocate the local memory address based on the length information of the shared data.
